(19) United States
(12) Patent Application Publication
(10) Pub. No.: US 2026/0218826 A1
(43) Pub. Date: Jul. 30, 2026

(54) QUICK CONNECTORS INCLUDING ROTATABLE COVER FOR EXPOSING INDICIA

(71) Applicant: Toyoda Gosei Co., Ltd., Kiosu-shi (JP)

(72) Inventors: Aaron E. Ferdinande, Warren, MI (US); Kazuhisa Hatta, Novi, MI (US); Thomas Grzybowski, Fraser, MI (US); Alexander Thaden, Grand Blanc, MI (US)

(73) Assignee: Toyoda Gosei Co., Ltd., Kiosu-shi (JP)

(21) Appl. No.: 19/036,298

(22) Filed: Jan. 24, 2025

(51) Int. Cl. F16L 37/14

(52) U.S. Cl. CPC F16L 37/14; F16L 2201/10

(57) ABSTRACT

A quick connector includes a female member including a body defining a pocket, a cover positionable within the pocket of the female member, indicia provided on an outer surface of the body of the female member, and a male member insertable in an insertion direction into the female member. In response to the male member moving in the insertion direction within the female member, the male member contacts the cover to move the cover in a first rotation direction from a covered position in which the indicia is at least partially obstructed from view to an uncovered position in which the indicia is not obstructed from view.

### TECHNICAL FIELD

The present specification generally relates to quick connectors for connecting conduits and, more specifically, quick connectors including scannable indicia to confirm proper connection of components of the quick connector.

### BACKGROUND

Quick connectors for conduits are widely used in industries such as automotive, aerospace, and manufacturing to facilitate the secure and efficient joining of conduits for transport systems. These quick connectors are designed for rapid attachment and detachment. Recent advancements have integrated scannable indicia, such as QR codes, barcodes, or other machine-readable symbols, into the quick connectors. These codes enable operators or automated systems to verify proper attachment and alignment of the components of the quick connector, enhancing operational safety and reducing the risk of fluid loss or system failure.

Despite these developments, existing solutions often suffer from significant drawbacks. The incorporation of scannable indicia typically adds complexity to the design and manufacturing processes, requiring specialized materials, precise placement techniques, and sometimes additional electronic components for proper functionality. Furthermore, the readability of these indicia can degrade over time due to wear, contamination, or exposure to harsh environmental conditions, leading to operational inefficiencies or errors in verification. As a result, these systems are often costly and difficult to maintain, limiting their widespread adoption across industries that could benefit from them.

Therefore, there is a need for improved quick connectors and methods for integrating and displaying scannable codes that maintain durability, reliability, and simplicity.

### SUMMARY

In one embodiment, a quick connector includes: a female member including a body defining a pocket; a cover positionable within the pocket of the female member; indicia provided on an outer surface of the body of the female member or the cover; and a male member insertable in an insertion direction into the female member, wherein, in response to the male member moving in the insertion direction within the female member, the male member contacts the cover to move the cover in a first rotation direction along a circumference direction of the female member from a covered position in which the indicia is at least partially obstructed from view to an uncovered position in which the indicia is not obstructed from view.

In another embodiment, a quick connector includes: a female member including a body having an outer surface; a cover positionable within the female member; indicia provided on an outer surface of the body of the female member or the cover; a male member insertable in an insertion direction into the female member; a coupling member insertable into the female member from an end of the female member opposite the male member; and a locking element insertable into the female member to engage the male member and lock the male member within the female member, wherein, in response to the male member moving in the insertion direction within the female member, the male member contacts the cover to move the cover in a first rotation direction from a covered position in which the indicia is at least partially obstructed from view to an uncovered position in which the indicia is not obstructed from view.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an embodiment of a quick connector, according to one or more embodiments shown and described herein;

FIG. 2 schematically depicts a perspective view of a male member of the quick connector of FIG. 1, according to one or more embodiments shown and described herein;

FIG. 3 schematically depicts a top view of a female member of the quick connector of FIG. 1, according to one or more embodiments shown and described herein;

FIG. 4 schematically depicts a partial cross-sectional view of the female member of the quick connector of FIG. 1, according to one or more embodiments shown and described herein;

FIG. 5 schematically depicts a perspective view of a cover of the quick connector of FIG. 1, according to one or more embodiments shown and described herein;

FIG. 6 schematically depicts a partial top view of the cover inserted into a pocket formed in the female member of the quick connector of FIG. 1, according to one or more embodiments shown and described herein;

FIG. 7 schematically depicts a partial perspective view of the quick connector of FIG. 1 with the cover in the covered position within the female member and a finger of the male member contacting the cover, according to one or more embodiments shown and described herein;

FIG. 8 schematically depicts a front view of the quick connector of FIG. 1 with the male member in a disengaged position and the cover in a covered position, according to one or more embodiments shown and described herein;

FIG. 9 schematically depicts a front view of the quick connector of FIG. 1 with the male member in an engaged position and the cover in an uncovered position, according to one or more embodiments shown and described herein;

FIG. 10 schematically depicts a partial perspective view of the quick connector of FIG. 1 with the cover in the uncovered position within the female member and the finger of the male member received within a first finger receiving slot of the female member, according to one or more embodiments shown and described herein;

FIG. 11 schematically depicts another embodiment of a cover, according to one or more embodiments shown and described herein;

FIG. 12 schematically depicts a front view of another embodiment of a quick connector with a male member in a disengaged position and the cover of FIG. 11 in a covered position, according to one or more embodiments shown and described herein;

FIG. 13 schematically depicts a front view of the quick connector of FIG. 12 with the male member in an engaged position and the cover of FIG. 11 in an uncovered position, according to one or more embodiments shown and described herein;

FIG. 14 schematically depicts a top view of another embodiment of a female member, according to one or more embodiments shown and described herein;

FIG. 15 schematically depicts a partial cross-sectional view of the female member of FIG. 14, according to one or more embodiments shown and described herein;

FIG. 16 schematically depicts another embodiment of a cover, according to one or more embodiments shown and described herein;

FIG. 17 schematically depicts a front view of another embodiment of a quick connector with a male member in a disengaged position and the cover of FIG. 16 in a covered position, according to one or more embodiments shown and described herein; and

FIG. 18 schematically depicts a front view of the quick connector of FIG. 17 with the male member in an engaged position and the cover of FIG. 16 in an uncovered position, according to one or more embodiments shown and described herein.

### DETAILED DESCRIPTION

Embodiments described herein are directed to quick connectors for connecting conduits and permitting indicia to be visible when the components of the quick connector are properly connected. In embodiments, the quick connectors are designed for rapid attachment and detachment of fluid conduits while ensuring leak-proof seals for the fluids being conveyed. The quick connector includes a female member having a body defining a pocket, indicia provided on an outer surface of the body of the female member or the cover, a male member insertable in an insertion direction into the female member, and a cover positionable within the pocket of the female member. In response to the male member moving in the insertion direction within the female member, the male member contacts the cover to move the cover in a first rotation direction along a circumference direction of the female member from a covered position in which the indicia is at least partially obstructed from view to an uncovered position in which the indicia is not obstructed from view. Various embodiments of the quick connector and the operation of the quick connector are described in more detail herein. Whenever possible, the same reference numerals will be used throughout the drawings to refer to the same or like parts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

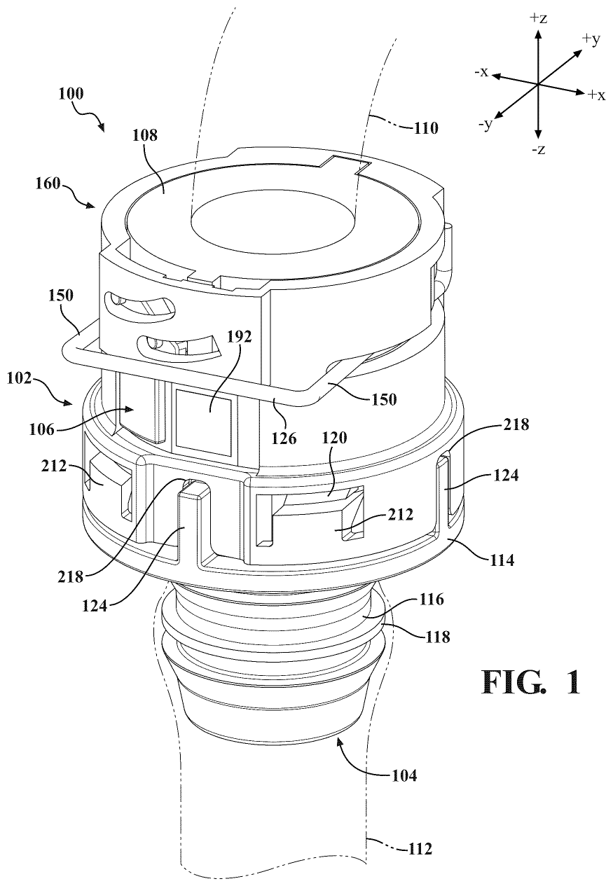

Referring now to FIG. 1, a quick connector 100 is illustrated according to one or more embodiments described herein. The quick connector 100 may generally include a female member 102, a coupling member 104 insertable into the female member 102, a cover 106 received within the female member 102, and a male member 108 insertable into the female member 102 from an end of the female member 102 opposite the coupling member 104.

The quick connector 100 is operable to place a first tube 110 extending from the male member 108 in fluid communication with a second tube 112 extending from the coupling member 104. The coupling member 104 includes a base 114 and a tube receiving portion 116 extending from the base 114. The tube receiving portion 116 includes a plurality of flanges 118 circumscribing the tube receiving portion 116. The second tube 112 is configured to surround the flanges 118 and form a press fit arrangement to secure the second tube 112 to the coupling member 104. In embodiments, the coupling member 104 includes one or more locking hooks 120. In embodiments, the coupling member 104 includes a plurality of locking hooks 120 spaced apart from one another around a circumference of the base 114 of the coupling member 104. However, any number of locking hooks 120 may be provided. The locking hooks 120 may be formed from a resilient material so as to flex upon a force being applied against the locking hooks 120. The coupling member 104 further includes one or more vertical posts 124 formed on the base 114. As shown in FIG. 1, the coupling member 104 includes a plurality of vertical posts 124 spaced apart from one another around the circumference of the base 114 of the coupling member 104. Each of the vertical posts 124 are positioned between adjacent locking hooks 120. However, any number of vertical posts 124 may be provided.

Although not depicted, the male member 108 similarly includes a tube receiving portion extending in a direction opposite the coupling member 104 and includes a plurality of flanges circumscribing the tube receiving portion. The first tube 110 is configured to surround the flanges and form a press fit arrangement to secure the first tube 110 to the male member 108 in a manner similar to the second tube 112 engaging the tube receiving portion 116 of the coupling member 104. However, the first tube 110 may be connected to the male member 108 in any other suitable manner not depicted herein.

As described in more detail herein, when the male member 108 is moved from a disengaged position into an engaged position, as shown in FIG. 1, and properly inserted into the female member 102, the cover 106 is moved relative to the female member 102 along a circumference direction of the female member 102 from a covered position to an uncovered position, as shown in FIG. 1, to expose indicia 192 provided on the female member 102. Thereafter, a locking element 126 may be positioned on the female member 102 to engage the male member 108 and lock the male member 108 in the engaged position relative to the female member 102.

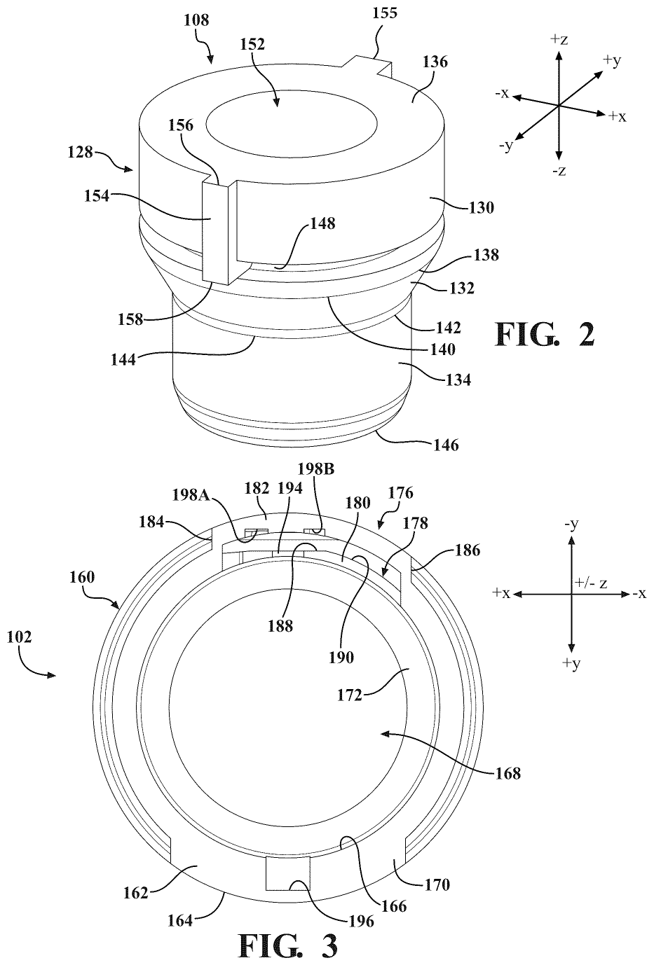

Referring now to FIG. 2, the male member 108 is shown separate from the other components. The male member 108 includes a body 128 having an upper portion 130, a transition portion 132, and a lower portion 134. The upper portion 130 has an upper end 136, and a lower end 138 opposite the upper end 136. The transition portion 132 has an upper end 140 and a lower end 142 opposite the upper end 140. The lower portion 134 has an upper end 144 and a lower end 146 opposite the upper end 144.

As shown, the upper portion 130 has a circular cross-sectional shape. However, it should be appreciated that the upper portion 130 may have any suitable shape. In embodiments, the transition portion 132 extends from the lower end 138 of the upper portion 130, and the lower portion 134 extends from the lower end 142 of the transition portion 132. In embodiments, the transition portion 132 tapers in a direction from the upper portion 130 to the lower portion 134. Accordingly, in such embodiments, the lower portion 134 has a diameter less than a diameter of the upper portion 130. As shown, the lower portion 134 has a circular cross-sectional shape similar to that of the upper portion 130. However, it should be appreciated that the lower portion 134 may have any suitable shape.

In embodiments, as shown, a recess 148 is formed in the body 128 of the male member 108 between the upper portion 130 and the transition portion 132. When provided, the recess 148 is configured to receive opposite arms 150 of the locking element 126 (FIG. 1). A channel 152 is formed within the male member 108 extending through the upper portion 130, the transition portion 132, and the lower portion 134 to permit fluid to pass through the male member 108 between the first tube 110 and the second tube 112 (FIG. 1). As noted above, although not depicted, the male member 108 may include a tube receiving portion extending from the upper portion 130 of the body 128 in a direction opposite the lower portion 134 of the body 128 and including a plurality of ribs circumscribing the tube receiving portion. The first tube 110 may be configured to surround the ribs and form a press fit arrangement to secure the first tube 110 to the male member 108, thereby directing fluid to flow through the channel 152.

The male member 108 includes a first finger 154 and a second finger 155 extending in an outward radial direction from the body 128. As shown, the male member 108 includes the first finger 154 and the second finger 155 provided on diametrically opposite sides of the upper portion 130 of the body 128. However, it should be appreciated that the male member 108 may include any number of second fingers 155 such as, for example, one second finger 155 or more than two second fingers 155. Each of the first finger 154 and the second finger 155 have an upper end 156 and a lower end 158 opposite the upper end 156. In embodiments, as shown, the lower end 158 of the first finger 154 extends into the recess 148. However, it should be appreciated that the recess 148 need not be provided and, thus, the lower end 158 of the first finger 154 would not extend into the recess 148. As shown, the lower end 158 of the first finger 154 is planar such that the lower end 158 extends along a plane parallel to an X-Y plane. However, in other embodiments, the lower end 158 of the first finger 154 may extend along a plane that is not parallel to the X-Y plane. Accordingly, the lower end 158 of the first finger 154 may have a tapered shape. As shown in FIG. 2, the first finger 154 and the second finger 155 have different widths. In embodiments, the first finger 154 has a width that is less than a width of the second finger 155.

Although the first finger 154 and the second finger 155 are shown extending along an entire length of the upper portion 130 of the body 128 from the upper end 156 to the lower end 158 of the first finger 154 and the second finger 155, the first finger 154 and the second finger 155 may extend along less than an entire length of the upper portion 130. In other embodiments, the first finger 154 and the second finger 155 may be provided on a different location of the body 128 such as, for example, the transition portion 132 and/or the lower portion 134.

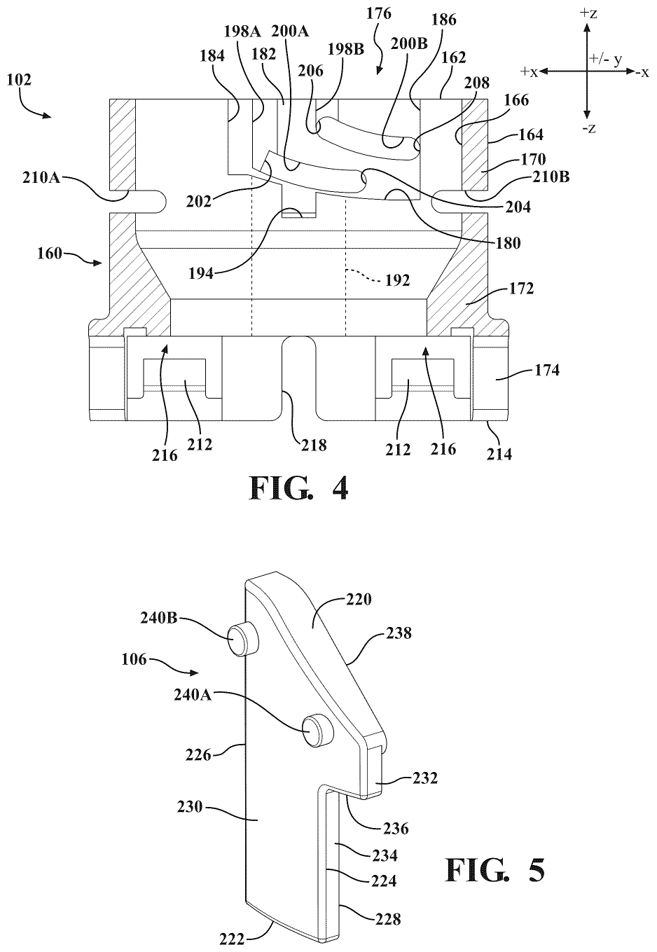

Referring now to FIGS. 3 and 4, the female member 102 is shown separate from the other components. The female member 102 includes a body 160 having an upper end 162, an outer surface 164, and an inner surface 166. The inner surface 166 defines a channel 168 extending through the body 160 in which the male member 108 (FIG. 2) is received. The body 160 includes an upper portion 170 at the upper end 162, a transition portion 172 extending from the upper portion 170, and a lower portion 174 (FIG. 4) extending from the transition portion 172 in a direction opposite the upper portion 170. As shown, the inner surface 166 of the body 160 at the upper portion 170 has a shape that generally corresponds to a shape of the upper portion 130 of the body 128 of the male member 108 (FIG. 2). The inner surface 166 of the body 160 of female member 102 at the transition portion 172 has a shape that generally corresponds to a shape of the transition portion 132 of the body 128 of the male member 108. The inner surface 166 of the body 160 of the female member 102 at the lower portion 174 has a shape that generally corresponds to a shape of the lower portion 134 of the body 128 of the male member 108.

A protruding section 176 is formed in the body 160 of the female member 102 and extends in an outward radial direction to define a pocket 178. The protruding section 176 includes a lower cutaway wall 180 and a protruding wall 182 spaced apart from the lower cutaway wall 180 between which the pocket 178 is formed. The lower cutaway wall 180 and the protruding wall 182 extend between a first side wall 184 and a second side wall 186 opposite the first side wall 184. The protruding wall 182 has a curvature corresponding to the curvature of the body 160 within the upper portion 170. An outer surface of the lower cutaway wall 180 is recessed radially inwardly toward the inner surface 166 of the body 160. Accordingly, the outer surface 164 of the body 160 at the lower cutaway wall 180 defines a planar wall segment 188 extending from the first side wall 184 of the protruding section 176, and a curved wall segment 190 extending between the planar wall segment 188 and the second side wall 186 of the protruding section 176. It should be appreciated that the planar wall segment 188 and the curved wall segment 190 may extend across the upper portion 170 and the transition portion 172 of the body 160. In other embodiments, the planar wall segment 188 and the curved wall segment 190 extend across only the upper portion 170 of the body 160. In other embodiments, the planar wall segment 188 and the curved wall segment 190 extend across only the transition portion 172 of the body 160.

As shown in FIG. 1, indicia 192 is provided on the planar wall segment 188 of the outer surface 164 of the body 160 across the upper portion 170 and the transition portion 172 of the body 160. The indicia 192 may be provided on the planar wall segment 188 in any suitable manner. For example, the indicia 192 may be secured to the planar wall segment 188 by being adhered, printed, fastened, or the like. As shown, the indicia 192 terminates at the lower portion 174 of the body 160. However, in embodiments, the indicia 192 may continue to extend along the lower portion 174 of the body 160. The indicia 192 may be any suitable visual indicator. The indicia 192 may be scannable and readable by a handheld digital device. For example, the indicia 192 may be a QR code, barcode, machine-readable symbols, and the like.

Referring again to FIG. 3, in embodiments, a first finger receiving slot 194 is formed in the lower cutaway wall 180 within the protruding section 176 and extends toward the transition portion 172. In embodiments, a second finger receiving slot 196 is formed in the inner surface 166 of the body 160 diametrically opposed from the first finger receiving slot 194 and extends from the upper end 162 of the body 160 toward the transition portion 172. As described in more detail herein, the first finger receiving slot 194 and the second finger receiving slot 196 are configured to receive the first finger 154 and the second finger 155, respectively, of the male member 108 (FIG. 2). In embodiments, the female member 102 includes only the first finger receiving slot 194. In other embodiments, the female member 102 includes additional second finger receiving slots 196 corresponding to receive additional second fingers 155 of the male member 108 (FIG. 2). As shown in FIG. 3, the first finger receiving slot 194 and the second finger receiving slot 196 have different widths and the first finger receiving slot 194 corresponds to the width of the first finger 154 and the second finger receiving slot 196 corresponds to the width of the second finger receiving slot 196. In embodiments, the first finger receiving slot 194 has a width that is less than a width of the second finger receiving slot 196. As the width of the first finger receiving slot 194 corresponds to the width of the first finger 154, the second finger 155 is inhibited from being inserted into the first finger receiving slot 194 to ensure the proper orientation of the male member 108 when being inserted into the female member 102.

In embodiments, the protruding wall 182 includes a first vertical groove 198A and a second vertical groove 198B formed on an inner surface of the protruding wall 182 and extend from the upper end 162 of the body 160. However, it should be appreciated that any number of vertical grooves may be formed on the inner surface of the protruding wall 182 such as, for example, one vertical groove or more than two vertical grooves.

Referring again to FIG. 4, a cross-sectional view of the female member 102 is shown. As shown, the lower cutaway wall 180 of the protruding section 176 slopes from the first side wall 184 to the second side wall 186 in a direction opposite the upper end 162 of the body 160. The first vertical groove 198A and the second vertical groove 198B terminate at a first channel 200A and a second channel 200B, respectively. The first channel 200A includes a proximal end 202 and a distal end 204 opposite the proximal end 202. Similarly, the second channel 200B includes a proximal end 206 and a distal end 208 opposite the proximal end 206.

The first channel 200A and the second channel 200B are spaced apart from one another and extend from the first vertical groove 198A and the second vertical groove 198B, respectively, toward the second side wall 186 of the protruding section 176. As shown, a distance between first side wall 184 and the proximal end 202 of the first channel 200A is less than a distance between the first side wall 184 and the proximal end 206 of the second channel 200B. Additionally, a distance between the second side wall 186 and the distal end 208 of the second channel 200B is less than a distance between the second side wall 186 and the distal end 204 of the first channel 200A. Moreover, a distance between the lower cutaway wall 180 and the distal end 204 of the first channel 200A is less than a distance between the lower cutaway wall 180 and the distal end 208 of the second channel 200B.

In embodiments, a first length of the first channel 200A defined between the proximal end 202 and the distal end 204 of the first channel 200A is less than a second length of the second channel 200B defined between the proximal end 206 and the distal end 208 of the second channel 200B. In other embodiments, the first length of the first channel 200A is greater than the second length of the second channel 200B. In other embodiments, the first length of the first channel 200A is equal to the second length of the second channel 200B.

The first channel 200A and the second channel 200B each extend completely through a thickness of the protruding wall 182. However, in embodiments, the first channel 200A and the second channel 200B extend only partially through the thickness of the protruding wall 182. In embodiments, as shown, the first channel 200A and the second channel 200B have an arcuate shape. In other embodiments, the first channel 200A and the second channel 200B have a linear shape.

Referring still to FIG. 4, a first locking slot 210A and a second locking slot 210B are formed in opposite sides of the upper portion 170 of the body 160 of the female member 102. As described in more detail herein, the first locking slot 210A and the second locking slot 210B permit the arms 150 of the locking element 126 (FIG. 1) to be inserted through the female member 102 and lock the male member 108 (FIG. 2) in position within the female member 102. It should be appreciated that the number and location of the first locking slot 210A and the second locking slot 210B may differ than that depicted herein.

As shown in FIG. 4, the female member 102 includes one or more locking flanges 212 provided on the lower portion 174 of the body 160. As shown in the cross-sectional view of FIG. 4, a pair of locking flanges 212 are provided. However, it should be appreciated that any number of locking flanges 212 are provided around a circumference of the lower portion 174 of the body 160 of the female member 102. The locking flanges 212 extend from a lower end 214 of the body 160 of the female member 102 opposite the upper end 162 of the body 160 and terminate within respective locking windows 216 formed in the lower portion 174 of the body 160. The locking flanges 212 may be formed from a resilient material so as to flex upon a force being applied against the locking flanges 212. As described in more detail herein, the locking flanges 212 are configured to engage respective locking hooks 120 of the coupling member 104 (FIG. 1), thereby locking the coupling member 104 to the female member 102. Additionally, one or more post receiving grooves 218 are formed in the lower portion 174 of the body 160 of the female member 102. Although only a single post receiving groove 218 is shown in FIG. 4, a plurality of post receiving grooves 218 are illustrated in FIG. 1. The post receiving grooves 218 are formed in the lower portion 174 of the body 160 and extend from the lower end 214 of the body 160.

As shown in FIG. 4, the indicia 192 is illustrated in phantom as being provided on the outer surface 164 of the body 160 and extending across the upper portion 170 and the transition portion 172 of the body 160. The indicia 192 is provided below the first vertical groove 198A and the second vertical groove 198B along the Z axis.

Referring now to FIG. 5, the cover 106 is shown separate from the other components. The cover 106 includes an upper end 220, a lower end 222 opposite the upper end 220, a first side wall 224 extending between the upper end 220 and the lower end 222, and a second side wall 226 opposite the first side wall 224 extending between the upper end 220 and the lower end 222. The cover 106 also includes an inner surface 228 and an outer surface 230 opposite the inner surface 228.

The first side wall 224 of the cover 106 includes an upper side wall segment 232, a lower side wall segment 234, and a shoulder 236 extending between the upper side wall segment 232 and the lower side wall segment 234. The shoulder 236 extends from the upper side wall segment 232 in a direction toward the second side wall 226 of the cover 106. Accordingly, a width of the cover 106 between the second side wall 226 and the upper side wall segment 232 of the first side wall 224 is greater than a width of the cover 106 between the second side wall 226 and the lower side wall segment 234 of the first side wall 224.

The upper end 220 of the cover 106 slopes downwardly from the second side wall 226 to the upper side wall segment 232 of the first side wall 224. Accordingly, a height of the cover 106 between the lower end 222 and the upper end 220 is greater at the second side wall 226 than at the first side wall 224. In embodiments, the upper end 220 of the cover 106 defines a protuberance 238 that has an increased thickness greater than a thickness between the outer surface 230 and the inner surface 228 of the cover 106. Additionally, in embodiments, the thickness of the upper end 220 of the cover 106 is greater at the second side wall 226 of the cover 106 than at the first side wall 224 of the cover 106. However, in other embodiments, the thickness of the upper end 220 may be constant between the first side wall 224 and the second side wall 226 of the cover 106.

As shown, a first nub 240A and a second nub 240B extend from the outer surface 230 of the cover 106. The first nub 240A is located closer to the first side wall 224 than to the second side wall 226, and the second nub 240B is located closer to the second side wall 226 than to the first side wall 224. In embodiments, as shown, the first nub 240A and the second nub 240B each have a circular cross-sectional shape. However, the first nub 240A and the second nub 240B may have any suitable shape such as, for example, square, elliptical, linear, or the like. The first nub 240A and the second nub 240B may have the same size and/or shape. In other embodiments, the first nub 240A and the second nub 240B have a different size and/or shape. As described in more detail herein, the first nub 240A and the second nub 240B each have a diameter corresponding to a width of the first vertical groove 198A and the second vertical groove 198B, respectively.

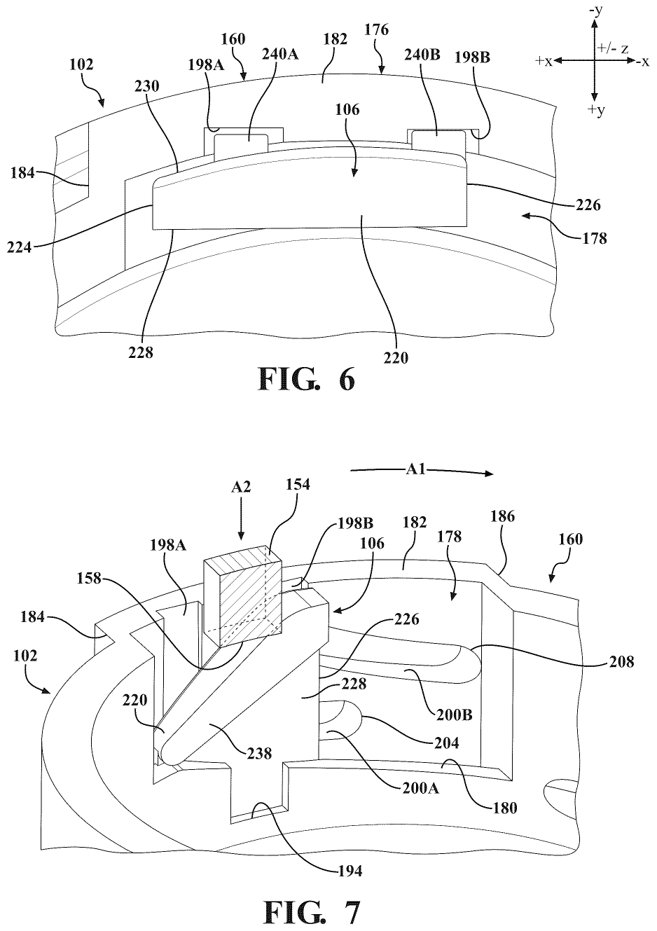

Referring now to FIG. 6, a top plan view is illustrated of the cover 106 being inserted into the female member 102. To insert the cover 106 into the female member 102, the cover 106 is inserted into the pocket 178 formed in the female member 102 between the protruding wall 182 and the lower cutaway wall 180 of the protruding section 176. The cover 106 is then lowered such that the first nub 240A and the second nub 240B are received within the first vertical groove 198A and the second vertical groove 198B, respectively. Accordingly, the first vertical groove 198A and the second vertical groove 198B guide the cover 106 into the pocket 178 such that the cover 106 may then be lowered into the pocket 178 and the first nub 240A and the second nub 240B received within the first channel 200A and the second channel 200B (FIG. 4), respectively.

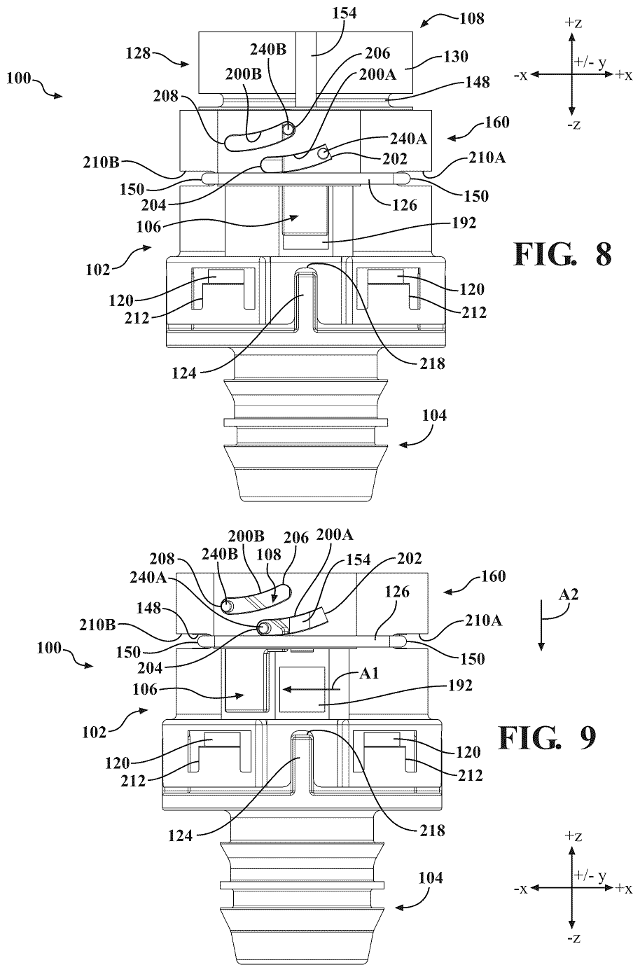

Referring now to FIG. 7, the cover 106 is shown lowered into the pocket 178 formed in the female member 102. With the cover 106 lowered into the pocket 178, the protuberance 238 contacts the lower cutaway wall 180 to stabilize and permit smooth movement of the cover 106 from the covered position, as shown in FIG. 8, to the uncovered position, as shown in FIG. 9. Additionally, the protuberance 238 contacting the lower cutaway wall 180 reduces the amount of weight on the first nub 240A and the second nub 240B received within the first vertical groove 198A and the second vertical groove 198B (FIG. 5), respectively.

As shown, the first finger 154 of the male member 108 is illustrated positioned above the cover 106 such that the lower end 222 of the first finger 154 contacts the protuberance 238 of the cover 106. As described in more detail herein, contact on the cover 106 by the lower end 158 of the first finger 154 moves the cover 106 in a first rotation direction denoted by arrow A1 from the covered position to the uncovered position. The first rotation direction of arrow A1 extends along the inner surface 166 of the body 160 of the female member 102 along the protruding wall 182, which is curved to correspond to the curvature of the rest of the body 160 within the upper portion 170. In other words, the first rotation direction of arrow A1 indicates a rotational movement along a circumference direction of the female member 102.

Referring now to FIG. 8, the coupling member 104 is shown inserted into the female member 102. Specifically, the locking hooks 120 of the coupling member 104 are engaged by the locking flanges 212 of the female member 102 to inhibit removal of the coupling member 104 from the female member 102. Additionally, as shown, the vertical posts 124 of the coupling member 104 are received with the post receiving grooves 218 formed in the female member 102 to inhibit rotation of the female member 102 relative to the coupling member 104.

As shown in FIG. 8, the male member 108 is in the disengaged position with the upper portion 130 of the body 128 not inserted into the female member 102. Even with the male member 108 in the disengaged position, the arms 150 of the locking element 126 are shown positioned within the first locking slot 210A and the second locking slot 210B formed in the female member 102. The locking element 126 is permitted to be inserted into the first locking slot 210A and the second locking slot 210B with the male member 108 in the disengaged position due to the width of the locking element 126, as defined between the arms 150, being greater than a width of the transition portion 132 of the male member 108 extending through the female member 102.

As shown in FIG. 8, the cover 106 is in the covered position within the female member 102. With the cover 106 in the covered position, the first nub 240A is positioned at the proximal end 202 of the first channel 200A formed in the female member 102, and the second nub 240B is positioned at the proximal end 206 of the second channel 200B formed in the female member 102. As described herein, the first nub 240A and the second nub 240B are movable long the first channel 200A and the second channel 200B, respectively, as the cover 106 moves from the covered position to the uncovered position. In the covered position, the cover 106 conceals at least a portion of the indicia 192 such that the indicia 192 is not fully visible from the view illustrated in FIG. 8. In some embodiments, the indicia 192 is completely concealed by the cover 106 when in the covered position. In other embodiments, such as that illustrated in FIG. 8, only a portion of the indicia 192 is concealed by the cover 106 when in the covered position. It should be appreciated that by covering at least a portion of the indicia 192 by the cover 106, the indicia 192 may not be properly scanned by an electronic device to confirm insertion of the male member 108 relative to the female member 102.

Referring now to FIG. 9, the male member 108 is shown moved in an insertion direction in the −Z direction denoted by arrow A2 to be fully inserted into the female member 102 and positioned into the engaged position from the disengaged position illustrated in FIG. 8. In response to the male member 108 being positioned in the engaged position, the cover 106 is moved in the first rotation direction of arrow A1 from the covered position to the uncovered position. Specifically, the cover 106 is moved due to the lower end 158 (FIG. 7) of the first finger 154 contacting and applying a force against the upper end 220 (FIG. 7) of the cover 106 to move the cover 106, as illustrated in FIG. 7 and described herein. As movement of the cover 106 is constrained by the first nub 240A and the second nub 240B being received within the first channel 200A and the second channel 200B, respectively, downward movement of the male member 108 causes rotational movement of the cover 106 in the first rotation direction of arrow A1 relative to the female member 102. The first rotation direction of arrow A1, which is the direction of the rotational movement of the cover 106, is different than the insertion direction of arrow A2 of the male member 108. The first rotation direction of arrow A1 is a rotational direction while the insertion direction of arrow A1 is a linear direction.

Once the male member 108 is positioned in the engaged position, the cover 106 is positioned in the uncovered position. With the cover 106 in the covered position, the indicia 192 is not exposed. With the cover 106 in the uncovered position, the first nub 240A is located at the distal end 204 of the first channel 200A, and the second nub 240B is located at the distal end 208 of the second channel 200B. Additionally, in the uncovered position, the cover 106 is moved away from the indicia 192 provided on the female member 102 such that the indicia 192 is fully exposed. With the indicia 192 fully exposed, the indicia 192 may be scanned by an electronic device to confirm insertion of the male member 108 relative to the female member 102. Moreover, as the male member 108 is inserted into the female member 102, the male member 108 applies an outward force against the arms 150 of the locking element 126 to spread the arms 150 of the locking element 126.

Once the recess 148 formed in the male member 108 is aligned with the first locking slot 210A and the second locking slot 210B formed in the female member 102, the locking element 126 is permitted to engage the recess 148, thereby locking the male member 108 in position relative to the female member 102. To permit removal of the male member 108, opposite sides of the locking element 126 may be spread apart to allow the male member 108 to be moved in a direction opposite that denoted by arrow A2.

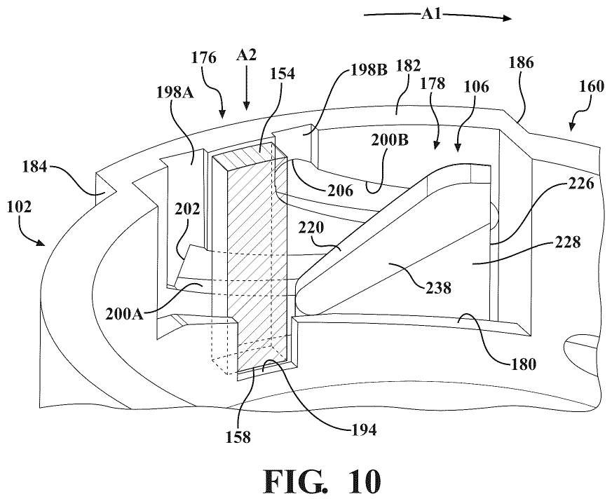

Referring now to FIG. 10, the cover 106 is shown in the uncovered position after the first finger 154 of the male member 108 has moved the cover 106 in the first rotation direction of arrow A1. For ease of illustration, only the first finger 154 of the male member 108 is illustrated. However, with the cover 106 in the uncovered position and the first finger 154 positioned as illustrated in FIG. 10, it should be understood that the male member 108 is in the engaged position. Specifically, with the male member 108 in the engaged position, the first finger 154 is received within the first finger receiving slot 194 formed in the lower cutaway wall 180. With the first finger 154 received within the first finger receiving slot 194, rotation of the male member 108 relative to the female member 102 is inhibited.

With the cover 106 in the uncovered position, as moved in the first rotation direction of arrow A1 by the first finger 154, the first nub 240A is located at the distal end 204 of the first channel 200A, and the second nub 240B is located at the distal end 208 of the second channel 200B. As described herein, during movement of the cover 106 between the covered position and the uncovered position, the protuberance 238 abuts against the lower cutaway wall 180 to maintain smooth movement of the cover 106 within the pocket 178 and reduce the amount of force on the first nub 240A and the second nub 240B imparted by the first channel 200A and the second channel 200B.

The cover 106 may be moved back to the covered position by removing the locking element 126 (FIG. 9) and moving the male member 108 in a direction opposite that of arrow A2 out of the engaged position. Once the male member 108 is moved out of the engaged position relative to the female member 102, the cover 106 may be moved back into the covered position. Movement of the cover 106 back into the covered position may be performed by manual operation. However, although not depicted herein, in embodiments, a biasing member may be positioned between the second side wall 186 of the protruding section 176 and the second side wall 226 of the cover 106. With the male member 108 no longer obstructing movement of the cover 106, a force applied by the biasing member against the cover 106 moves the cover 106 from the uncovered position toward the covered position in a second rotation direction opposite that of the first rotation directed depicted by arrow A1.

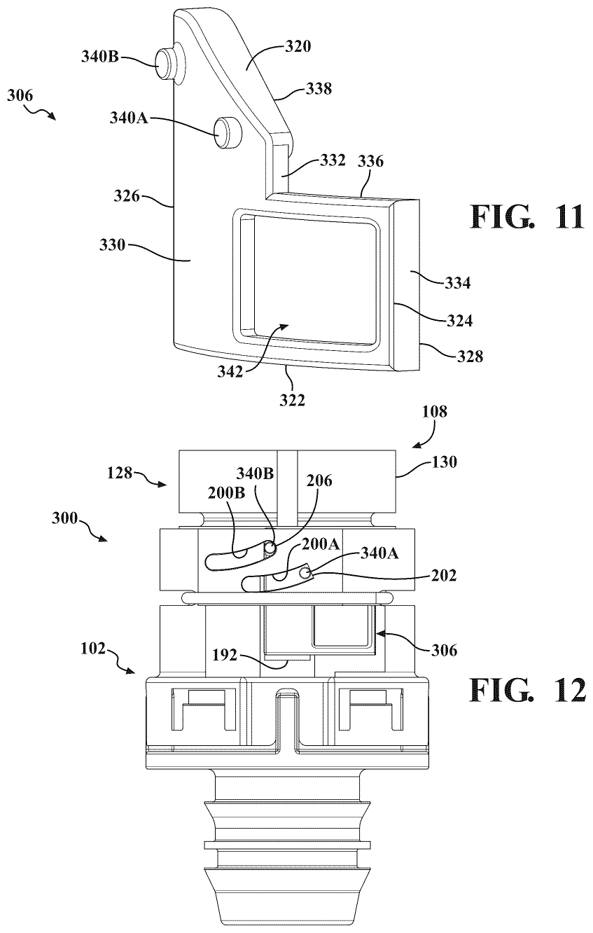

Referring now to FIG. 11, another embodiment of a cover 306 is illustrated. The cover 306 includes an upper end 320, a lower end 322 opposite the upper end 320, a first side wall 324 extending between the upper end 320 and the lower end 322, and a second side wall 326 opposite the first side wall 324 extending between the upper end 320 and the lower end 322. The cover 306 also includes an inner surface 328 and an outer surface 330 opposite the inner surface 328.

The first side wall 324 of the cover 306 includes an upper side wall segment 332, a lower side wall segment 334, and a shoulder 336 extending between the upper side wall segment 332 and the lower side wall segment 334. The shoulder 336 extends from the upper side wall segment 332 in a direction opposite the second side wall 326 of the cover 306. Accordingly, a width of the cover 306 between the second side wall 326 and the upper side wall segment 332 of the first side wall 324 is less than a width of the cover 306 between the second side wall 326 and the lower side wall segment 334 of the first side wall 324.

The upper end 320 of the cover 306 slopes downwardly from the second side wall 326 to the upper side wall segment 332 of the first side wall 324. Accordingly, a height of the cover 306 between the lower end 322 and the upper end 320 is greater at the second side wall 326 than at the first side wall 324. In embodiments, the upper end 320 of the cover 306 defines a protuberance 338 that has an increased thickness greater than a thickness between the outer surface 330 and the inner surface 328 of the cover 306. Additionally, in embodiments, the thickness of the upper end 320 of the cover 306 is greater at the second side wall 326 of the cover 306 than at the first side wall 324 of the cover 306. However, in other embodiments, the thickness of the upper end 320 may be constant between the first side wall 324 and the second side wall 326 of the cover 306.

A window 342 is formed in the cover 306 extending between the inner surface 328 and the outer surface 330 between the lower end 322 and the shoulder 336 of the first side wall 324. The window 342 is spaced apart from the second side wall 326 such that the window 342 is positioned closer to the first side wall 324 than the second side wall 326. As shown, the window 342 has a perimeter defining a square shape. However, the perimeter of the window 342 may have any suitable shape such as, for example, rectangular, circular, or the like. As shown, an edge of the window 342 closer to the second side wall 326 extends past the upper side wall segment 332 of the first side wall 324. However, in embodiments, the window 342 may be positioned wholly between the lower end 322 and the shoulder 336 of the first side wall 324.

As shown, a first nub 340A and a second nub 340B extend from the outer surface 330 of the cover 306. The first nub 340A is located closer to the first side wall 324 than to the second side wall 326, and the second nub 340B is located closer to the second side wall 326 than to the first side wall 324. In embodiments, as shown, the first nub 340A and the second nub 340B each have a circular cross-sectional shape. However, the first nub 340A and the second nub 340B may have any suitable shape such as, for example, square, elliptical, linear, or the like. The first nub 340A and the second nub 340B may have the same size and/or shape. In other embodiments, the first nub 340A and the second nub 340B have a different size and/or shape. As described in more detail herein, the first nub 340A and the second nub 340B each have a diameter corresponding to a width of the first vertical groove 198A and the second vertical groove 198B, respectively, of the female member 102.

Referring now to FIG. 12, a quick connector 300 is illustrated including the female member 102, the coupling member 104, the male member 108, and the cover 306. As shown in FIG. 12, the male member 108 is in the disengaged position with the upper portion 130 of the body 128 not inserted into the female member 102, and the cover 306 is in the covered position within the female member 102. With the cover 306 in the covered position, the first nub 340A is positioned at the proximal end 202 of the first channel 200A formed in the female member 102, and the second nub 340B is positioned at the proximal end 206 of the second channel 200B formed in the female member 102. As described herein, the first nub 340A and the second nub 340B are movable long the first channel 200A and the second channel 200B, respectively, as the cover 306 moves from the covered position to the uncovered position. In the covered position, the cover 306 conceals at least a portion of the indicia 192 such that the indicia 192 is not fully visible from the view illustrated in FIG. 12. In some embodiments, the indicia 192 is completely concealed by the cover 306 when in the covered position. In other embodiments, such as that illustrated in FIG. 12, only a portion of the indicia 192 is concealed by the cover 306 when in the covered position. It should be appreciated that by covering at least a portion of the indicia 192 by the cover 306, the indicia 192 may not be properly scanned by an electronic device to confirm insertion of the male member 108 relative to the female member 102.

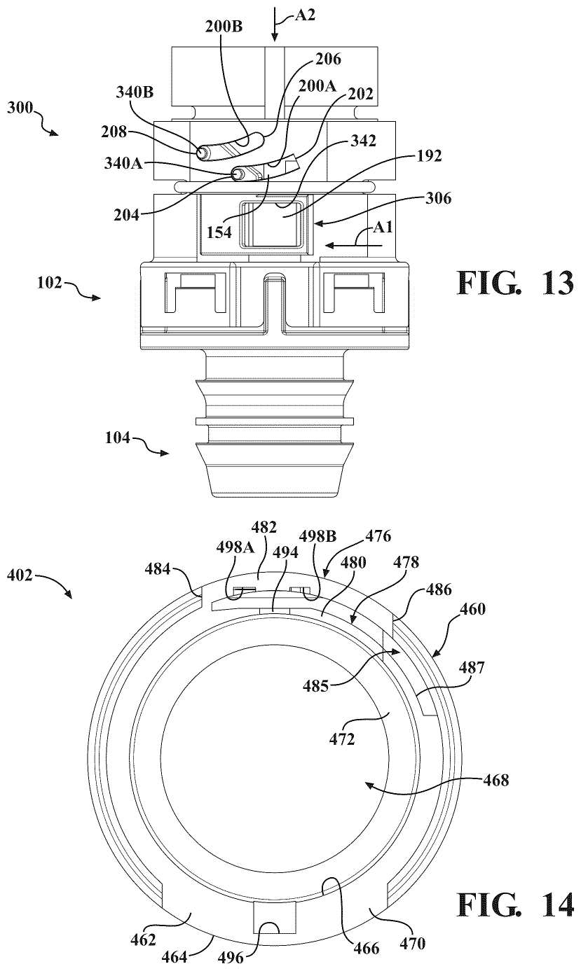

Referring now to FIG. 13, the male member 108 is shown moved in the insertion direction in the −Z direction denoted by arrow A2 to be fully inserted into the female member 102 and positioned into the engaged position from the disengaged position illustrated in FIG. 12. In response to the male member 108 being positioned in the engaged position, the cover 306 is moved in the first rotation direction of arrow A1 from the covered position to the uncovered position. Specifically, the cover 306 is moved due to the lower end 158 (FIG. 7) of the first finger 154 contacting and applying a force against the upper end 320 (FIG. 11) of the cover 306 to move the cover 306. As movement of the cover 306 is constrained by the first nub 340A and the second nub 340B being received within the first channel 200A and the second channel 200B, respectively, downward movement of the male member 108 causes rotational movement of the cover 306 in the first rotation direction of arrow A1 relative to the female member 102.

Once the male member 108 is positioned in the engaged position, the cover 306 is positioned in the uncovered position. With the cover 306 in the uncovered position, the first nub 340A is located at the distal end 204 of the first channel 200A, and the second nub 340B is located at the distal end 208 of the second channel 200B. Additionally, in the uncovered position, the cover 306 is moved such that the indicia 192 is positioned within the window 342 formed in the cover 306 and fully exposed. With the indicia 192 fully exposed, the indicia 192 may be scanned by an electronic device to confirm insertion of the male member 108 relative to the female member 102.

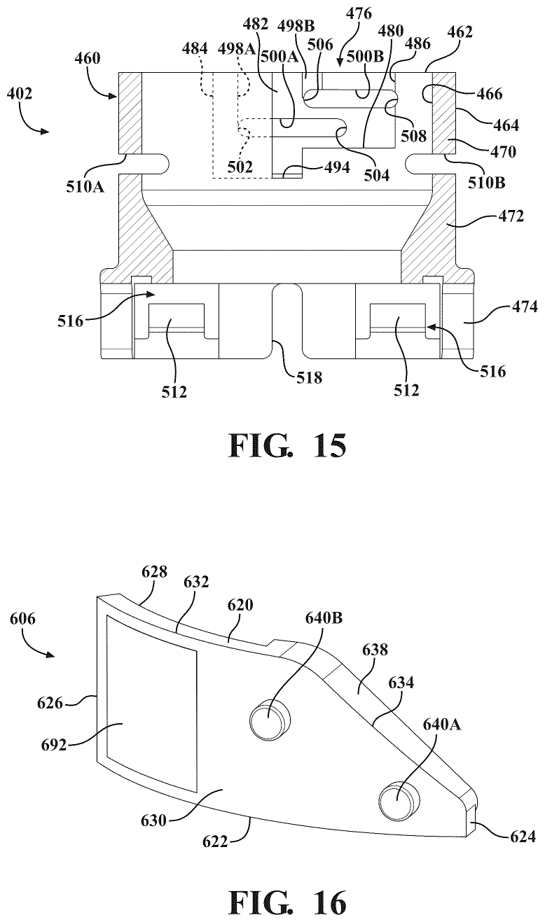

Referring now to FIGS. 14 and 15, another embodiment of a female member 402 is illustrated. The female member 402 includes a body 460 having an upper end 462, an outer surface 464, and an inner surface 466. The inner surface 466 defines a channel 468 extending through the body 460 in which the male member 108 (FIG. 2) is received. The body 460 includes an upper portion 470 at the upper end 462, a transition portion 472 extending from the upper portion 470, and a lower portion 474 extending from the transition portion 472 in a direction opposite the upper portion 470. As shown, the inner surface 466 of the body 460 at the upper portion 470 has a shape that generally corresponds to a shape of the upper portion 130 of the body 128 of the male member 108 (FIG. 2). The inner surface 466 of the body 460 of female member 402 at the transition portion 472 has a shape that generally corresponds to a shape of the transition portion 132 of the body 128 of the male member 108. The inner surface 466 of the body 460 of the female member 402 at the lower portion 474 has a shape that generally corresponds to a shape of the lower portion 134 of the body 128 of the male member 108.

A protruding section 476 is formed in the body 460 of the female member 402 and extends in an outward radial direction to define a pocket 478. The protruding section 476 includes a lower cutaway wall 480 and a protruding wall 482 spaced apart from the lower cutaway wall 480 between which the pocket 478 is formed. The lower cutaway wall 480 and the protruding wall 482 extend between a first side wall 484 and a second side wall 486 opposite the first side wall 484. A gap 485 is formed in the second side wall 486 to permit a portion of the cover 306 to move out of the pocket 478 and into a recess 487 formed in the outer surface 464 of the female member 402, as described in more detail herein. The protruding wall 482 has a curvature corresponding to the curvature of the body 460 within the upper portion 470. An outer surface of the lower cutaway wall 480 is recessed radially inwardly toward the inner surface 466 of the body 460.

Referring still to FIG. 14, in embodiments, a first finger receiving slot 494 is formed in the lower cutaway wall 480 within the protruding section 476 and extends toward the transition portion 472. In embodiments, a second finger receiving slot 496 is formed in the inner surface 466 of the body 460 diametrically opposed from the first finger receiving slot 494 and extends from the upper end 462 of the body 460 toward the transition portion 472. As described in more detail herein, the first finger receiving slot 494 and the second finger receiving slot 496 are configured to receive the first finger 154 and the second finger 155, respectively, of the male member 108 (FIG. 2). In embodiments, the female member 402 includes only the first finger receiving slot 494. In other embodiments, the female member 402 includes additional second finger receiving slots 496 corresponding to receive additional second fingers 155 of the male member 108 (FIG. 2).

In embodiments, the protruding wall 482 includes a first vertical groove 498A and a second vertical groove 498B formed on an inner surface of the protruding wall 482 and extend from the upper end 462 of the body 460. However, it should be appreciated that any number of vertical grooves may be formed on the inner surface of the protruding wall 482 such as, for example, one vertical groove or more than two vertical grooves.

Referring again to FIG. 15, a cross-sectional view of the female member 402 is shown. As shown, the lower cutaway wall 480 of the protruding section 476 extends parallel to the upper end 462 of the body 460. The first vertical groove 498A and the second vertical groove 498B terminate at a first channel 500A and a second channel 500B, respectively. The first channel 500A includes a proximal end 502 and a distal end 504 opposite the proximal end 502. Similarly, the second channel 500B includes a proximal end 506 and a distal end 508 opposite the proximal end 506.

The first channel 500A and the second channel 500B are spaced apart from one another and extend from the first vertical groove 498A and the second vertical groove 498B, respectively, toward the second side wall 486 of the protruding section 476. As shown, a distance between the first side wall 484 and the proximal end 502 of the first channel 500A is less than a distance between the first side wall 484 and the proximal end 506 of the second channel 500B. Additionally, a distance between the second side wall 486 and the distal end 508 of the second channel 500B is less than a distance between the second side wall 486 and the distal end 504 of the first channel 500A. Moreover, a distance between the lower cutaway wall 480 and the distal end 504 of the first channel 500A is less than a distance between the lower cutaway wall 480 and the distal end 508 of the second channel 500B.

In embodiments, a first length of the first channel 500A defined between the proximal end 502 and the distal end 504 of the first channel 500A is less than a second length of the second channel 500B defined between the proximal end 506 and the distal end 508 of the second channel 500B. In other embodiments, the first length of the first channel 500A is greater than the second length of the second channel 500B. In other embodiments, the first length of the first channel 500A is equal to the second length of the second channel 500B.

The first channel 500A and the second channel 500B each extend completely through a thickness of the protruding wall 482. However, in embodiments, the first channel 500A and the second channel 500B extend only partially through the thickness of the protruding wall 482. In embodiments, as shown, the first channel 500A and the second channel 500B have a linear shape as opposed to the arcuate shape described here with respect to the female member 102 ((FIG. 4).

Referring still to FIG. 15, a first locking slot 510A and a second locking slot 510B are formed in opposite sides of the upper portion 470 of the body 460 of the female member 402. As described in more detail herein, the first locking slot 510A and the second locking slot 510B permit the arms 150 of the locking element 126 (FIG. 1) to be inserted through the female member 402 and lock the male member 108 (FIG. 2) in position within the female member 402. It should be appreciated that the number and location of the first locking slot 510A and the second locking 510B may differ than that depicted herein.

As shown in FIG. 15, the female member 402 includes one or more locking flanges 512 provided on the lower portion 474 of the body 460. As shown in the cross-sectional view of FIG. 15, a pair of locking flanges 512 are provided. However, it should be appreciated that any number of locking flanges 512 are provided around a circumference of the lower portion 474 of the body 460 of the female member 402. The locking flanges 512 extend from a lower end 514 of the body 460 of the female member 402 opposite the upper end 462 of the body 460 and terminate within respective locking windows 516 formed in the lower portion 474 of the body 460. The locking flanges 512 may be formed from a resilient material so as to flex upon a force being applied against the locking flanges 512. As described in more detail herein, the locking flanges 512 are configured to engage respective locking hooks 120 of the coupling member 104 (FIG. 1), thereby locking the coupling member 104 to the female member 402. Additionally, one or more post receiving grooves 518 are formed in the lower portion 474 of the body 460 of the female member 402. Although only a single post receiving groove 518 is shown in FIG. 15, a plurality of post receiving grooves 518 may be provided. The post receiving grooves 518 are formed in the lower portion 474 of the body 460 and extend from the lower end 514 of the body 460.

Referring now to FIG. 16, another embodiment of a cover 606 is illustrated. The cover 606 includes an upper end 620, a lower end 622 opposite the upper end 620, a first side wall 624 extending between the upper end 620 and the lower end 622, and a second side wall 626 opposite the first side wall 624 extending between the upper end 620 and the lower end 622. The cover 606 also includes an inner surface 628 and an outer surface 630 opposite the inner surface 628. The upper end 620 of the cover 606 includes a planar segment 632 extending from the second side wall 626, and a tapered segment 634 extending between the planar segment 632 toward the first side wall 624.

The tapered segment 634 of the upper end 620 of the cover 606 slopes downwardly from the planar segment 632 to the first side wall 624. Accordingly, a height of the cover 606 between the lower end 622 and the upper end 620 is greater at the second side wall 626 than at the first side wall 624. In embodiments, the tapered segment 634 of the cover 606 defines a protuberance 638 that has an increased thickness greater than a thickness between the outer surface 630 and the inner surface 628 of the cover 606. Additionally, in embodiments, the thickness of the upper end 620 of the cover 606 is greater at the second side wall 626 of the cover 606 than at the first side wall 624 of the cover 606. However, in other embodiments, the thickness of the upper end 620 may be constant between the first side wall 624 and the second side wall 626 of the cover 606.

As shown, a first nub 640A and a second nub 640B extend from the outer surface 630 of the cover 606. The first nub 640A is located closer to the first side wall 624 than to the second side wall 626, and the second nub 640B is located closer to the second side wall 626 than to the first side wall 624. In embodiments, as shown, the first nub 640A and the second nub 640B each have a circular cross-sectional shape. However, the first nub 640A and the second nub 640B may have any suitable shape such as, for example, square, elliptical, linear, or the like. The first nub 640A and the second nub 640B may have the same size and/or shape. In other embodiments, the first nub 640A and the second nub 640B have a different size and/or shape. As described in more detail herein, the first nub 640A and the second nub 640B each have a diameter corresponding to a width of the first vertical groove 498A and the second vertical groove 498B, respectively.

The cover 606 includes indicia 692 provided closer to the second side wall 626 than to the first side wall 624 so as to be positioned wholly between the lower end 622 and the planar segment 632 of the upper end 620. The indicia 692 may be secured to the cover 606 in any suitable manner. For example, the indicia 692 may be secured to the cover 606 by being adhered, printed, fastened, or the like. The indicia 692 may be any suitable visual indicator. The indicia 692 may be scannable and readable by a handheld digital device. For example, the indicia 692 may be a QR code, barcode, machine-readable symbols, and the like.

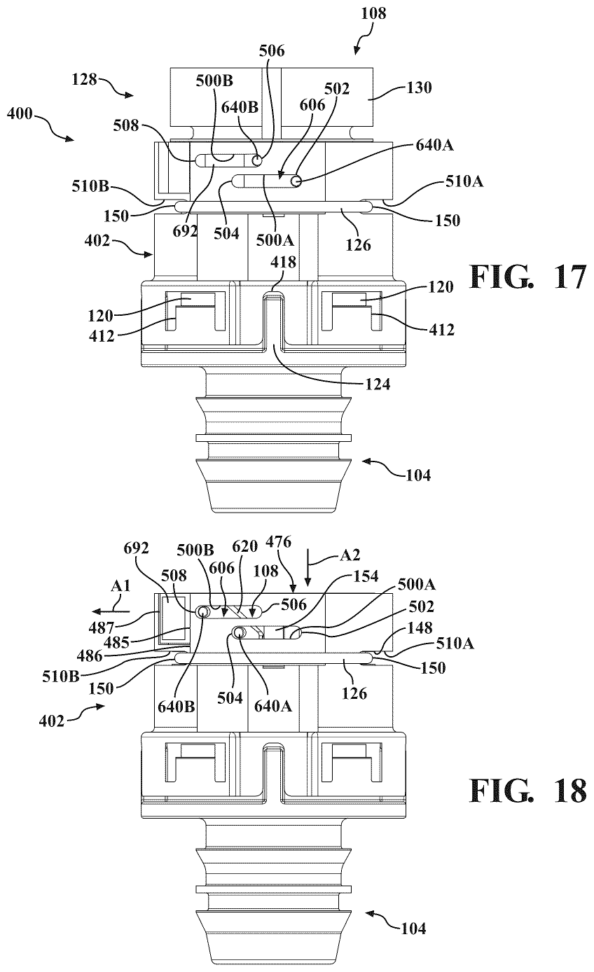

Referring now to FIG. 17, a quick connector 400 is illustrated including the female member 402, the coupling member 104, the male member 108, and the cover 606. As shown in FIG. 17, the coupling member 104 is inserted into the female member 402. Specifically, the locking hooks 120 of the coupling member 104 are engaged by the locking flanges 412 of the female member 402 to inhibit removal of the coupling member 104 from the female member 402. Additionally, as shown, the vertical posts 124 of the coupling member 104 are received with the post receiving grooves 418 formed in the female member 402 to inhibit rotation of the female member 402 relative to the coupling member 104.

As shown in FIG. 17, the male member 108 is in the disengaged position with the upper portion 130 of the body 128 not inserted into the female member 402. Even with the male member 108 in the disengaged position, the arms 150 of the locking element 126 are shown positioned within the first locking slot 510A and the second locking slot 510B formed in the female member 402. The locking element 126 is permitted to be inserted into the first locking slot 510A and the second locking slot 510B with the male member 108 in the disengaged position due to the width of the locking element 126, as defined between the arms 150, being greater than a width of the transition portion 132 of the male member 108 extending through the female member 402.

As shown in FIG. 17, the cover 606 is in the covered position within the female member 402. With the cover 606 in the covered position, the first nub 640A is positioned at the proximal end 502 of the first channel 500A formed in the female member 402, and the second nub 640B is positioned at the proximal end 506 of the second channel 500B formed in the female member 402. As described herein, the first nub 640A and the second nub 640B are movable long the first channel 500A and the second channel 500B, respectively, as the cover 406 moves from the covered position to the uncovered position. In the covered position, the indicia 692 provided on the cover 606 is at least partially concealed by the body 460 of the female member 402 such that the indicia 692 is not fully visible from the view illustrated in FIG. 17. In some embodiments, the indicia 692 is completely concealed by the female member 402 when in the covered position. In other embodiments, such as that illustrated in FIG. 17, only a portion of the indicia 692 is concealed by the female member 402 when in the covered position. It should be appreciated that by covering at least a portion of the indicia 692 by the female member 402, the indicia 692 may not be properly scanned by an electronic device to confirm insertion of the male member 108 relative to the female member 402.

Referring now to FIG. 18, the male member 108 is shown moved in the insertion direction in the −Z direction denoted by arrow A2 to be fully inserted into the female member 402 and positioned into the engaged position from the disengaged position illustrated in FIG. 17. In response to the male member 108 being positioned in the engaged position, the cover 606 is moved in the first rotation direction of arrow A1 from the covered position to the uncovered position. Specifically, the cover 606 is moved due to the lower end 158 of the first finger 154 contacting and applying a force against the upper end 620 of the cover 606 to move the cover 606. As movement of the cover 606 is constrained by the first nub 640A and the second nub 640B being received within the first channel 500A and the second channel 500B, respectively, downward movement of the male member 108 causes rotational movement of the cover 606 in the first rotation direction of arrow A1 relative to the female member 402.

Once the male member 108 is positioned in the engaged position, the cover 606 is positioned in the uncovered position. With the cover 606 in the uncovered position, the first nub 640A is located at the distal end 504 of the first channel 500A, and the second nub 640B is located at the distal end 508 of the second channel 500B. Additionally, in the uncovered position, the cover 606 is moved such that cover extends through the gap 485 formed in the second side wall 486 of the protruding section 476 and the indicia 692 is positioned within the recess 487 formed in the female member 402 and fully exposed. With the indicia 692 fully exposed, the indicia 692 may be scanned by an electronic device to confirm insertion of the male member 108 relative to the female member 402. Moreover, as the male member 108 is inserted into the female member 402, the male member 108 applies an outward force against the arms 150 of the locking element 126 to spread the arms 150 of the locking element 126.

Once the recess 148 formed in the male member 108 is aligned with the first locking slot 510A and the second locking slot 510B formed in the female member 402, the locking element 126 is permitted to engage the recess 148, thereby locking the male member 108 in position relative to the female member 402. To permit removal of the male member 108, opposite sides of the locking element 126 may be spread apart to allow the male member 108 to be moved in a direction opposite that denoted by arrow A2.

From the above, it is to be appreciated that defined herein is a quick connector including a female member having a body defining a pocket, indicia provided on an outer surface of the body of the female member or the cover, a male member insertable in an insertion direction into the female member, and a cover positionable within the pocket of the female member. In response to the male member moving in the insertion direction within the female member, the male member contacts the cover to move the cover in a first rotation direction along a circumference direction of the female member from a covered position in which the indicia is at least partially obstructed from view to an uncovered position in which the indicia is not obstructed from view.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A quick connector comprising:
a female member including a body defining a pocket;
a cover positionable within the pocket of the female member;
indicia provided on an outer surface of the body of the female member; and
a male member insertable in an insertion direction into the female member,
wherein, in response to the male member moving in the insertion direction within the female member, the male member contacts the cover to move the cover in a first rotation direction along a circumference direction of the female member from a covered position in which the indicia is at least partially obstructed from view to an uncovered position in which the indicia is not obstructed from view.

2. The quick connector of claim 1, wherein:
the pocket is defined within a protruding section of the body; and
the protruding section includes a protruding wall extending between a first side wall and a second side wall.

3. The quick connector of claim 1, wherein:
a first channel is formed in an inner surface of the body; and
the cover includes a first nub received within the first channel, the first nub movable along the first channel as the cover moves from the covered position to the uncovered position.

4. The quick connector of claim 3, wherein a first vertical groove is formed on the inner surface of the body and terminates at the first channel.

5. The quick connector of claim 3, wherein:
a second channel is formed in the inner surface of the body; and
the cover includes a second nub received within the second channel, the second nub movable along the second channel as the cover moves from the covered position to the uncovered position.

6. The quick connector of claim 5, wherein a second vertical groove is formed on the inner surface of the body and terminates at the second channel.

7. The quick connector of claim 5, wherein the first channel has a first length and the second channel has a second length less than the first length.

8. The quick connector of claim 1, wherein:
the male member includes a finger extending from an outer surface of the male member; and
the female member includes a first finger receiving slot for receiving the finger as the male member extends into the female member and moves in the insertion direction.

9. The quick connector of claim 8, wherein:
the cover includes a first side wall, a second side wall opposite the first side wall, and an upper end that extends and slopes between the first side wall and the second side wall; and
the finger of the male member contacts the upper end of the cover to move the cover in the first rotation direction as the as the male member extends into the female member and moves in the insertion direction.

10. (canceled)

11. The quick connector of claim 1, wherein:
a window is formed in the cover; and
the indicia is positioned within the window when the cover is in the uncovered position.

12. (canceled)

13. A quick connector comprising:
a female member including a body having an outer surface;
a cover positionable within the female member;
indicia provided on an outer surface of the body of the female member or the cover;
a male member insertable in an insertion direction into the female member;
a coupling member insertable into the female member from an end of the female member opposite the male member; and
a locking element insertable into the female member to engage the male member and lock the male member within the female member,
wherein, in response to the male member moving in the insertion direction within the female member, the male member contacts the cover to move the cover in a first rotation direction from a covered position in which the indicia is at least partially obstructed from view to an uncovered position in which the indicia is not obstructed from view.

14. The quick connector of claim 13, wherein:
the coupling member includes one or more locking hooks; and
the female member includes one or more locking flanges, the locking hooks engaging the locking flanges when then coupling member is inserted into the female member to lock the coupling member to the female member.

15. The quick connector of claim 13, wherein:
a pair of locking slots are formed in opposite sides of the female member;
the male member includes a recess formed in an outer surface of the male member; and
the locking element includes a pair of opposite arms configured to extend through the pair of locking slots formed in the female member and be received within the recess formed in the outer surface of the male member to inhibit removal of the male member from the female member.

16. The quick connector of claim 13, wherein:
a first channel and a second channel are formed in an inner surface of the body of the female member; and
the cover includes a first nub received within the first channel and a second nub received within the second channel, the first nub movable along the first channel and the second nub movable along the second channel as the cover moves from the covered position to the uncovered position.

17. The quick connector of claim 13, wherein:
the cover includes a first side wall, a second side wall opposite the first side wall, and an upper end that extends and slopes between the first side wall and the second side wall; and
the male member includes a finger that contacts the upper end of the cover to move the cover in the first rotation direction as the as the male member extends into the female member and moves in the insertion direction.

18. The quick connector of claim 13, wherein the indicia is provided on the outer surface of the body of the female member.

19. The quick connector of claim 18, wherein:
a window is formed in the cover; and
the indicia positioned within the window when the cover is in the uncovered position.

20. The quick connector of claim 13, wherein:
the indicia is provided on the cover; and
the indicia is positioned within a recess formed in the outer surface of the female member when the cover is in the uncovered position.

21. A quick connector comprising:
a female member including a body defining a pocket, a first channel formed in an inner surface of the body;
a cover positionable within the pocket of the female member, the cover including a first nub received within the first channel;
indicia provided on an outer surface of the body of the female member or the cover; and
a male member insertable in an insertion direction into the female member,
wherein, in response to the male member moving in the insertion direction within the female member, the male member contacts the cover to move the cover in a first rotation direction along a circumference direction of the female member from a covered position in which the indicia is at least partially obstructed from view to an uncovered position in which the indicia is not obstructed from view,
wherein the first nub is movable along the first channel as the cover moves from the covered position to the uncovered position.

22. The quick connector of claim 21, wherein:
the indicia is provided on the cover; and
the indicia is positioned within a recess formed in the outer surface of the female member when the cover is in the uncovered position.
